(19) United States
(12) Patent Application Publication
(10) Pub. No.: US 2010/0287280 A1
(43) Pub. Date: Nov. 11, 2010

(54) System and method for cloud computing based on multiple providers

(76) Inventor: Gal Sivan, Ramot Menashe (IL)

Correspondence Address: DR. D. GRAESER LTD., 9003 FLORIN WAY, UPPER MARLBORO, MD, 20772, US

(21) Appl. No.: 12/437,555

(22) Filed: May 8, 2009

(51) Int. Cl. G06F 15/16; G06F 9/50

(52) U.S. Cl. 709/226; 718/104

(57) ABSTRACT

A system and method for generating cloud computing based on a plurality of providers. The system preferably manages resources from a plurality of providers and allocates these resources to a plurality of consumers.

### FIELD OF THE INVENTION

The present invention generally relates to grid computing. More specifically, the present invention relates to transferring, replicating, and managing virtual machines between geographically separated computing devices and optimizing computer image in a Grid/Cluster environment.

### BACKGROUND OF THE INVENTION

IT (Information Technology) has become a must in most organization. Computers are used for storing and manipulating data in big organizations such as banks, insurance companies and the like and in almost all SMBs (small and medium businesses). Computer resources are required for keeping data and for performing applications such as generating reports, answering queries and the like. Computer resources are expensive and require maintenance. In many organizations, data centers are required. A data center is a facility used to house computer systems and associated components, such as telecommunications and storage systems. It generally includes redundant or backup power supplies, redundant data communications connections, environmental controls (e.g., air conditioning, fire suppression) and security devices. Such data centers are expensive, difficult to maintain and consume a lot of electricity mainly for cooling the plurality of computers. As a result, many businesses, instead of owning their own infrastructure, rent infrastructure and thus avoid capital expenditure and consume resources as a service, paying instead for what they use. The infrastructure is rented from big enterprises such as, for example AMAZON EC2. The technology which is used for such a solution is called cloud computing. Cloud computing is mainly a virtualization layer over the traditional data center structure. Such a technology has security and reliability problems, since the resource consumer is dependent on one provider only, therefore, such a solution does not solve the power consumption problem and in particular, the need for cooling such data centers. In order to support multiple providers in a cloud-computing environment, there is a need for grid middleware.

Grid computing (or the use of a computational grid) is the application of using several computers at the same time by using a distributed cluster computing. The first use of grid computing was for solving a scientific or technical problem that requires a great number of computer processing cycles or access to large amounts of data. Grid computing depends on software to divide and apportion pieces of a program among several computers, sometimes up to many thousands. Grid computing can also be thought of as distributed and large-scale cluster computing, as well as a form of network-distributed parallel processing. This technology has been applied to computationally intensive scientific, mathematical, and academic problems through volunteer computing (a type of distributed computing in which computer owners donate their computing resources, such as processing power and storage, to one or more “projects”). However, this technology has not been implemented as a commercial solution. Grid computing involves sharing of managed computing resources within and between organizations.

What distinguishes grid computing from conventional cluster computing systems is that grids tend to be more loosely coupled, heterogeneous, and geographically dispersed; also, while a computing grid may be dedicated to a specialized application, it is often constructed with the aid of general-purpose grid software libraries and middleware. Grid middleware is a specific software product, which enables the sharing of heterogeneous resources, and virtual organizations. It is installed and integrated into the existing infrastructure of the involved company or companies, and provides a special layer placed among the heterogeneous infrastructure and the specific user applications. Major Grid middle wares are Globus Toolkit, and UNICORE. The open source Globus® Toolkit is a fundamental enabling technology for the “Grid,” letting people share computing power, databases, and other tools securely online across corporate, institutional, and geographic boundaries without sacrificing local autonomy. The toolkit includes software services and libraries for resource monitoring, discovery, and management, plus security and file management. However, this tool is cumbersome and hard to maintain. UNICORE (UNiform Interface to COmputing REsources) is a Grid computing technology that provides seamless, secure, and intuitive access to distributed Grid resources such as supercomputers or cluster systems and information stored in databases. UNICORE was developed in two projects funded by the German ministry for education and research (BMBF). However, this solution is not suitable for dynamic and heterogeneous environments. In various European-funded projects UNICORE has evolved to a full-grown and well-tested Grid middleware system over the years. The usage of grid computing has evolved to commercial enterprises; Instead of using volunteer computing a new business model, which enables enterprises having big data centers as well as smaller business having IT resources, which are not always, utilize to rent the resources when they are not in use. These resources are being used by a plurality of consumers. One of the main challenges of such an implementation is the need to adjust the software of the host computer to the requirement of the current running task; such an adjustment is preferably done by replacing or changing the computer image of the hosting computer according the current running tasks.

The use of virtualization technology in cluster and grid environments is growing. These environments often involve virtual machine images being simultaneously provisioned (i.e., transferred) onto multiple computer systems. Virtual machine image transfer and management synchronization falls into two categories: Image Replication which can be implemented by Compressed/uncompressed image; Compressed image delta or Compressed delta of deltas and Data Transfer, which can be implemented by on-demand data transfer; server-initiated point-to-point data transfer; client-initiated point-to-point data transfer or server-initiated broadcast or multicast data transfer. Methods of data compression and data synchronization by creating diff objects (an object comprising the additional files comparing to the original files) exist and have been practice for years. The ability to create an Image from delta of deltas also exists but is limited to downloading the root image and all the deltas at a specific order from one provider. By this method, only one machine can create the images and all machines in the grid must download all deltas. Server-initiated point-to-point download methods impose severe loads on the network thereby limit scalability. Additional file transfers and virtual management procedures must continually be initiated at the central server in order to cope with the constantly varying nature of large computer system networks (e.g., new systems being added to increase a cluster size or to replace failed or obsolete systems). Users or tasks can also manually transfer virtual machine images prior to the executing of the virtual machine management; such a transfer can be done through a point-to-point file-transfer protocol. These transfers may be initiated from the computer systems (e.g., clients) where virtual machine images are to be used. Client-initiated point-to-point methods, like server-initiated methodologies, also impose severe loads on the network thereby limit scalability. Additional file transfers and virtual machine management procedures, have to continually be initiated at each client system in order to cope with the constantly varying nature of large computer networks (e.g., new computer systems being added to increase a cluster or grid size or to replace failed or obsolete systems). Such a manual transfer of virtual machine images can also be done though server-initiated multicast or broadcast files transfer protocol. Using such a methodology, virtual machine images are simultaneously transferred over the network to all computer systems. This scheme is, however, limited to installations where virtual machines are not integrated with cluster/grid workload management tools. Workload management tools require differentiated pre-configured virtual machines to operate; in addition, broadcasting requires synchronization with local virtual machine management facilities to be explicitly performed when data transfers are completed. Additional file transfers must continually be initiated at the central server to cope with, for example, the constantly varying nature of large computer networks. The virtual machine images being transferred to computer systems are normally pre-configured to operate within a specific cluster/grid environment. As a result, virtual machines are constrained in their use. Virtual machine image provisioning also frequently requires a corollary mechanism for provisioning virtual disk images, such as when virtual machine images and virtual disk images are stored separately instead of being kept as a single virtual machine image. Explicit user operation is further required to “mount” a virtual disk image within a virtual machine. Unfortunately, all the current solutions are suitable for bag of tasks which is a predefined list of tasks ad cannot work in an on demand dynamic and heterogeneous environments.

USA Publication No 20080222234 filed on May 23, 2002 teaches about an autonomous and asynchronous multicast virtual machine image transfer system. Such a system operates through computer failures, allows virtual machine image replication scalability in very large networks, persists in transferring a virtual machine image to newly introduced nodes or recovering nodes after the initial virtual machine image transfer process has terminated, and synchronizes virtual machine image transfer termination with virtual machine management utilities for operation. However, this application does not teach or suggest how to efficiently adjust the image to new software requirements.

U.S. Pat. No. 7,305,585, issued on Dec. 4, 2007, teaches an apparatus and methods to improve the speed, scalability, robustness and dynamism of data transfers to remote computers across a network. The object of this invention is to implement a multicast data transfer apparatus, which keeps operating through computer failures, allows data replication scalability to very large size networks, and which continues transferring data to newly introduced nodes even after the master data transfer process has terminated. However, this application does not teach or suggest how to efficiently adjust the computer image to new software requirements.

### SUMMARY OF THE INVENTION

The background art does not teach or suggest how to efficiently adjust the computer image to a new running task in grid computing environment and how to reduce the network load by such an adjustment. The background art does not teach or suggest an efficient cloud computing solution, which involves a plurality of providers, and thus reduce energy consumption and better utilize existing resources. The background art does not teach or suggest how to automatically adjust the operating system to a hypervisor installed on a machine. The background task does not teach or suggest how to decouple virtual machine transfer and management from cluster/grid processing environments without causing networking bottlenecks. The background art does not teach or suggest how to transfer virtual machine image, or any other computer image in large-scale installations wherein virtual machine images can be relocated in any part of a grid, without requiring pre-configuration or reconfiguration of workload management utilities.

The present invention overcomes the deficiencies of the background art by creating a system and method for managing the resource allocation from a plurality of providers to a plurality of consumers and for reducing the amount of files to be transferred when a change in a computer image is required. A change in a computer image is required when one or more tasks that have to run on the computer require a change the current running computer image.

According to one embodiment of the present invention, the method and system is implemented as a client server solution comprising three main entities. The first entity is a user, which can be a consumer, provider or both. By a consumer, it meant any entity such as for example a small enterprise, which requires the IT (Information Technology) resources. By a provider, it meant any entity, such as, for example a big enterprise, which rents the requested resources when these resources are not needed by this enterprise (for example, at nighttime). The second entity is a machine, which is preferably the provider current machine. The third entity is a task, which the consumer has to run. The task is preferably divided into Task Profile (environmental requirement) and task execution. Preferably, the consumer runs a plurality of tasks on a plurality of computers.

According to other embodiments of the present invention, whenever a consumer wishes to submit one or more tasks, the consumer is first authenticated and then the system preferably matches one or more machines according to the task profile and reserves the machines for this consumer. Matching is preferably done by choosing one or more machines with the same hardware requirements and similar software requirements. If the machine is ready to run the task, the machine notifies the server, which sends the consumer an authorization to initiate a P2P (point-to-point) connection to the execution machine and dispatches the tasks. The machine software, in most cases, does not completely meet the software requirements, which are needed for running the consumer's tasks. The machine image is updated in deltas as explained in more details in FIG. 6.

According to other embodiments of the present invention, a change in a computer image is required when one or more tasks that have to run on the computer require a change in the current running computer image. In cloud computing environment comprising a plurality of consumers and providers, such a change is likely to happen when a machine switches from serving one consumer to serving another consumer. According to these embodiments, each machine is preferably installed with one or more root images prior to being operable. By a root image, it meant a file comprising a specific operating system configured to work within a specific environment. Whenever a new consumer wishes to use a machine, the consumer sends a file defining the image which is required for running it's tasks. Such a file is called file list and is explained in great details in FIG. 5. The machine preferably compares the current image to the required image. Comparing is preferably done by comparing the required file list to the file list of the current available image or images. At the first update, the machine compares the required image to the root image that exists on the machine. The machine preferably chooses the image that is closer to the required image and sends a request for receiving the image delta. By image delta, it meant all the files that are missing in the current image and/or that are different from the existing version of the file that resides in the current image. A change in the file can occur, for example to a license file and the like. The request can be sent to the consumer computer, or to the other machines that currently serve this computer. After receiving the missing files, the machine preferably updates the image that was chosen as the most suitable and updates the file list of this image correspondingly. This process is explained in greater details in FIG. 6.

According to other embodiments of the present invention, the managing and transferring of images deltas as described in greater details in FIG. 6 can optionally be used by data centers for updating the images on the computers.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” or a “machine” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic drawing of the system.

FIG. 2 is a high-level exemplary flow diagram of the resource allocation scenario showing the interaction between the main elements in the system.

FIG. 3 is a schematic flow diagram of the server components.

FIG. 4 is a schematic exemplary diagram of the client that is installed in the consumer computer.

FIG. 5 is a schematic exemplary flow diagram of the resource allocation process.

FIGS. 6A-6D are exemplary diagrams describing the generator process, which builds the delta directory tree on a machine.

### DETAILED DESCRIPTION

The present invention is of a system and method for cloud computing middleware with multiple providers. More specifically, the present invention relates to transferring, replicating, executing, and managing tasks and virtual machines between geographically separated computing devices and optimizing computer image in a Grid/Cluster environment.

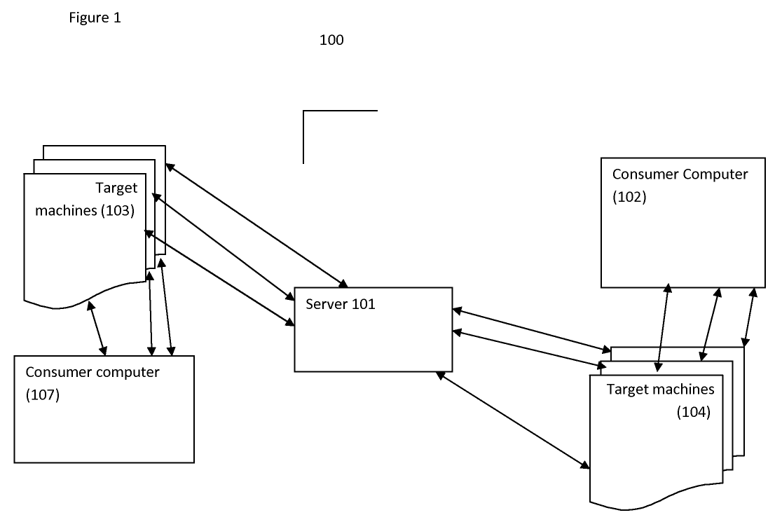

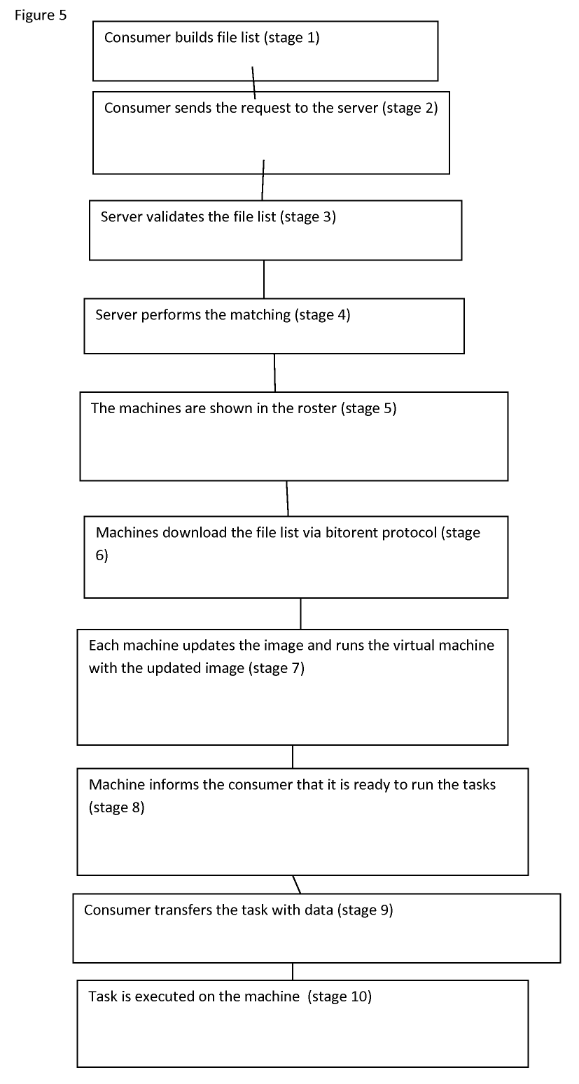

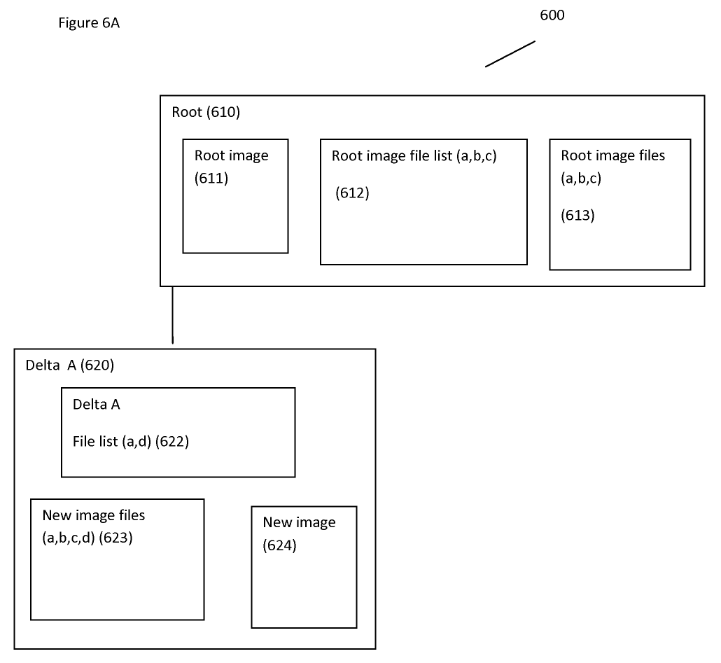

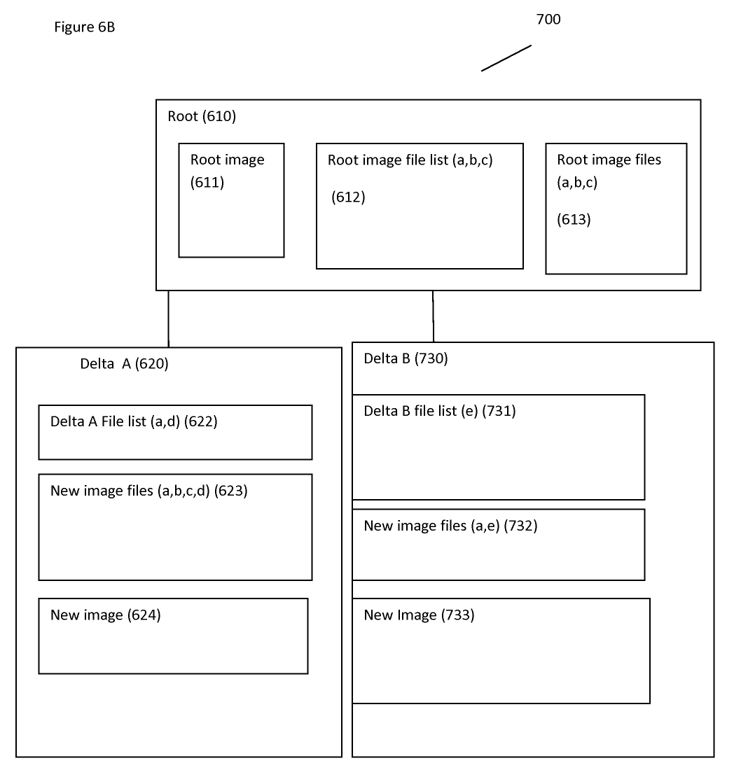

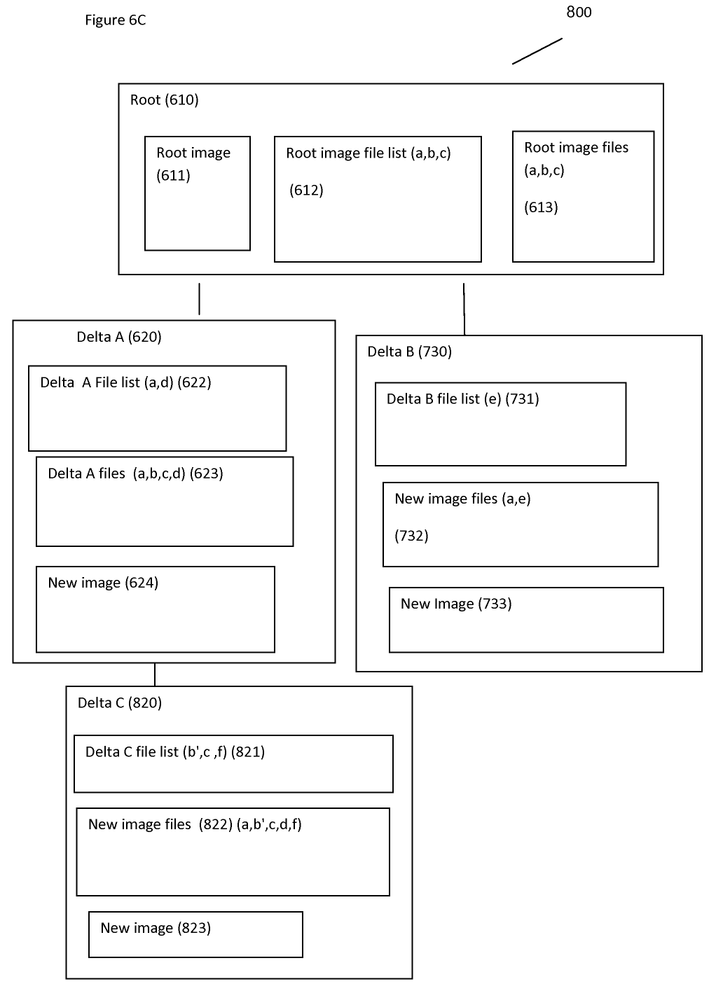

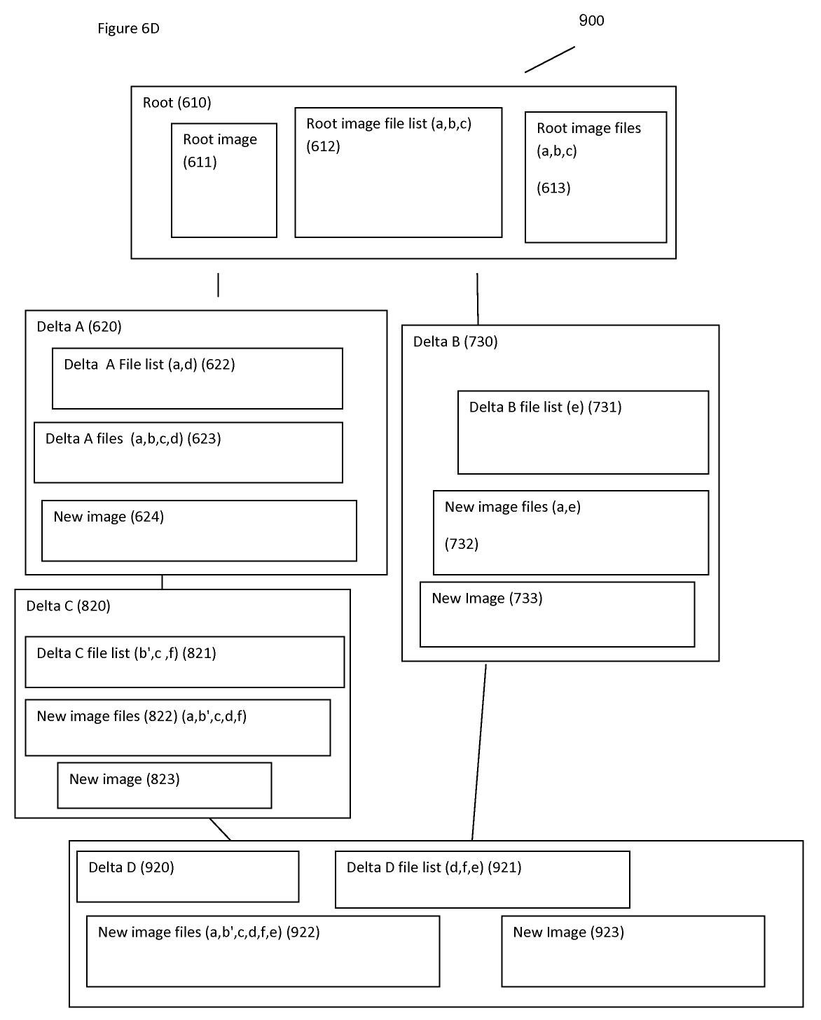

FIG. 1 is a schematic drawing of the system. As shown, system 100 features a server 101, a plurality of consumer computers (shown as consumer computer 102 and consumer computer 107) and a plurality of target machines (shown as 103 and 104). Server 101 communicates with target machines (shown as 103 and 104) and with consumer computers (shown as 107 and 102). Communication between consumer computers (shown as 107 and 102) and server 101, between server 101 and target machine (shown as 103 and 104), between consumer computers and target machine (for example between consumer computer 107 and target machines 103) is preferably done through IM (instant messaging) protocol, which can optionally be XMPP protocol. It should be noted that while server 101 can communicate with all consumer computers and target machines, consumer computer can communicate only with the target machines that are assigned to this computer (for example consumer computer 102 can communicate only with target machines 104) and target machines can only communicate with target machines that are allocated for the same consumer. Server 101 preferably receives requests from consumer computers (shown as consumer computer 102 and consumer computer 107) regarding allocation of resources. Server 101 performs resource allocation by matching the requests to the appropriate target machines (shown as 103, and 104). Matching is preferably done by finding machines having enough and compatible free hardware recourses and having the same root image as requested by the consumers. Server 101 also validates the requests arrived from the consumer computers (shown as consumer computer 102 and consumer computer 107) and more preferably validates the file list. Server 101 is also responsible for billing the consumers for the renting the machines. Consumer computer (shown as consumer computer 102 and consumer computer 107) uses a browser plug in software (not shown) that is installed in the computer, or alternatively communicates with the server via the WEB. Consumer computer (shown as 107 and 102) is responsible for sending a request to the server 101 for allocating resources upon a user request, for generating file lists upon initiating the request for resources and for saving such a file list in a directory, which can be accessed by the target computer. Software on consumer computer (not shown) is preferably able to monitor the tasks, which are running on the target machines (shown as 103 and 104). Target machines (shown as 103 and 104) requests from consumer computer (shown as 107 and 102) the image as explain in greater details in FIGS. 5 and 6 .Target machines (shown as 103 and 104) preferably comprise a plug in software (not shown); such a software is responsible for communicating with the server (for billing purposes, for example), and with the consumer computer, for downloading the file list and for monitoring the computer resources and running tasks. The system can optionally feature a gateway, (not shown) which bridges between the provider's cluster or consumers' cluster and other clusters in the network. In this case, the server communicates with the gateway (not shown) instead of communicating directly with the target machines or consumer computers.

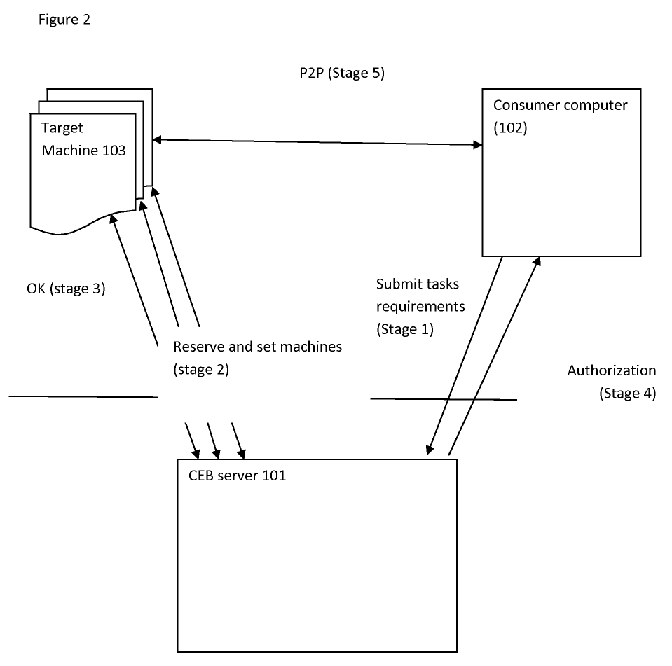

FIG. 2 is a high-level exemplary flow diagram of the resource allocation scenario showing the interaction between the main elements in the system. In stage 1 authenticate user submits tasks requirement to GridCEB server; such a request preferably comprises the file list and other requirements, such as hardware requirements. In stage 2, the server matches provider machines to the task profile and reserves the machines to the consumer. In stage 3, after adjusting the computer image to the requirement listed in the file list (as described in greater detains in FIGS. 5 and 6) and when the provider machine is ready to run the tasks, the machine notifies the CEB server, which, in stage 5, sends the Consumer an authorization to initiate a P2P (point to point) connection to the execution machine and dispatches the tasks.

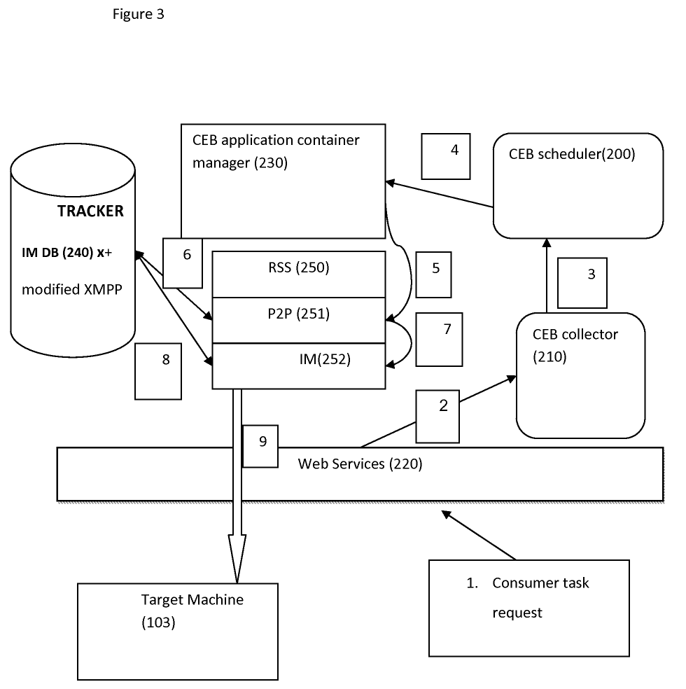

FIG. 3 is a schematic flow diagram of the server components. Server 101 preferably comprises the following main modules: Web Services (220), CEB P2P (point-to-point) content manager CEB Collector (210), CEB scheduler (200), CEB Image/Application and container management (230).

The CEB Collector module (210) preferably collects requests for computing resources from a plurality of consumers. The Web services module (220) is preferably responsible for the web infrastructure, which enables the consumers to submit tasks from anywhere by using the WEB. Alternatively, the consumer communicates with the server by using a client. The CEB P2P content manager module (240) preferably serves as a point to point server and an IM (instant messaging) server. According to one embodiment of the present invention, when XMPP is used as an IM protocol, the system modifies the XMPP protocol to support BitTorrent and RSS and thus reduces network load and eases the installation and configuration on the client side. CEB Collector module (210) is preferably responsible for matchmaking, tracking and discovering resources in CEB distributed system. The collector preferably monitors updates from providers regarding the machines and updates the machine availability accordingly. The CEB Collector preferably and optionally uses XML XMPP for communication between the CEB server and Machines. The Scheduler module (200) preferably queues tasks, which cannot be served immediately. Tasks are queues as result of the time, which is required for distributing the image deltas and due to temporary lake of resources in the pool. The scheduler preferably prioritizes the provider machines according to the similarity of the machine's image to the required image. CEB Application container manager module (230) preferably validates the consumer image delta integrity, before the consumer distributes the delta to the execution modes.

Referring now to the drawing: in stage 1 consumer request is sent to the web services module. In stage 2, the request is sent to the CEB collector module that performs the matchmaking for the consumer. In stage 3, the tasks are queued in the scheduler until the allocated machines are ready for performing the tasks. In stage 4, the CEB application container manager validates the consumer's image delta integrity, before the consumer distributes the delta to the execution nodes. In stages 5-9, the required image's delta is downloaded from the consumers to the machines. Downloading, is preferably done by using the file sharing protocol.

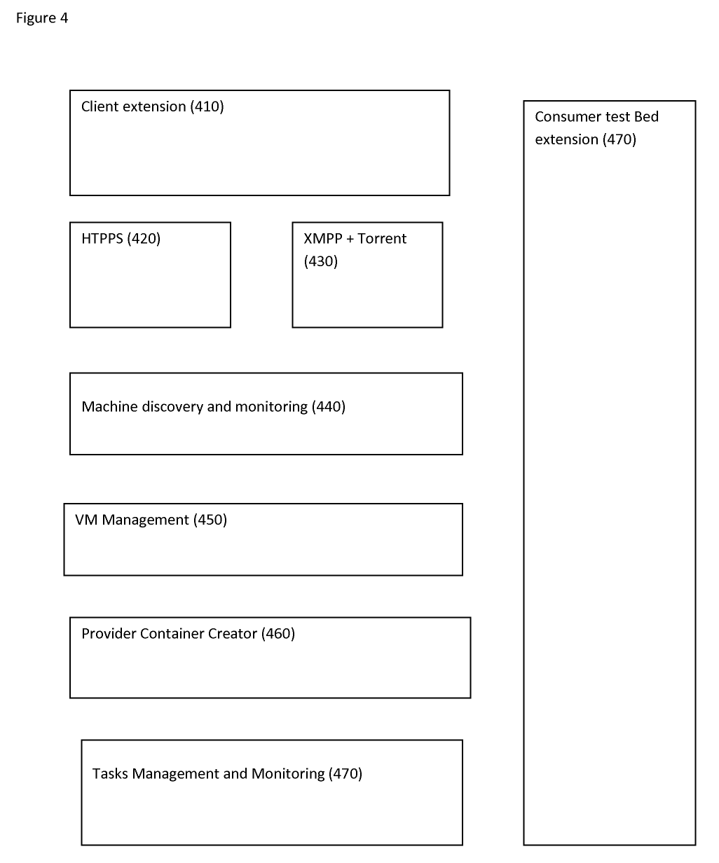

FIG. 4 is a schematic diagram of the client that is installed in the consumer computer or on the provider's machine. The client that resides on the consumer s computer is preferably responsible for security of the data, for communication with the server and with the machines and for transferring the delta image files, the tasks and the data to the machines, and optionally the test bed. The client on the machine is preferably responsible for security of the data, for communication with the server and with the machines and for updating the image. The client is preferably and optionally implemented as XPCOM browser extension. Securing the consumer (and provider) data is done by creating Virtual Machine (Over Hypervisor or Emulation) on the Provider's machine client for running the consumers tasks, and providing consumer restricted privileges on the created VM (virtual machine) by avoiding any privileges for the provider on the created Virtual Machine. The client is preferably built from seven components: Machine discovery and Monitoring, Task Management and Monitoring, VM (virtual machine,) management, point to point and IM (instant messaging) modified client, Consumer Test Bed, Provider Container creator and logger.

Referring now to the drawing: Client extension (410) is composed of the following modules: The discovery component (440) preferably transmits the core machine's profile to the collector on the CEB server at startup or upon a request from the server. The monitoring part notifies the collector whenever a problem or exceeded threshold occurs in a machine. Such problems are preferably found by periodically comparing one or more counters to predefined thresholds. Task Management and Monitoring (470) is preferably used by the client component to monitor Tasks. The task management part is preferably a self develop cross platforms library. This component reacts to the consumer (from anywhere) and to the CEB server commands. Task Management and Monitoring (470) also acts as a tasks dispatcher. VM Management (450) preferably automates the interface to hypervisors and/or OS (operating system) emulation. IM and point-to-point modified client (430) is used as a component for communication between the providers and consumer and for distributing the data needed for the task requirements. Consumer Test Bed (470) is a standalone extension. Consumer can optionally and preferably install Test Bed (470), in order to create the Application Container (compressed image's delta), the compressed user data, and customizations scripts. The OS (operating system) delta and user data are kept in separate files for providing better security and reliability. Provider Container creator (460) is a method to construct and distribute a Virtual Machine image based on the downloaded Application Container signature.

The container creator is a unique feature developed according to some embodiments of the present invention to take advantage of the grid infrastructure for provisioning the required Machine Image. Each node in the grid can create and distribute the required Image, thereby reducing computing and network load on provider's side. HTPPS (420) preferably provides the security layer between server and client.

FIG. 5 is a schematic exemplary flow diagram of the resource allocation process. The diagram, illustrates the scenario of allocating resources (machines) for a consumer who wishes to run one or more tasks. The diagram refers to the most common scenario in which the consumer runs a plurality of tasks on a plurality of machines. In stage 1, the consumer builds a file list. A file list is a file that defines the specifications of the image that is required for running the consumer's tasks. The file list identifies the image on which the tasks have to run. The file list is actually a list of files and file's description such as pathnames, ownership, mode, permissions, size and modification time; it also includes the file checksums. The file list is preferably built by plug-in software that is installed on the consumer's computer. In stage 2, the consumer transfers the request for resources to the system's server. Such a request preferably comprises but not limited to a list of tasks to be performed the file list, CPU load requirements, specification of files that cannot be included in the image and hardware requirement. In stage 3, the server validates the file list. In stage 4, if the file list is valid, the server performs matching. By matching, it meant finding all the target machines which meet the hardware requirement of the consumer and which comply with the software requirements, which are described in the file list or at least partially comply. By comply it meant having an image comprising the required files. In stage 5, as a result of the matching, the machines are added and are displayed, preferably in the roster (list of Instant Messaging contacts) of the consumer computer. In stage 6, each machine that was chosen by the server to run one or more of the consumer's task downloads the file list from the consumer's computer, preferably upon a request sent from the server. Downloading is preferably done by using the point-to-point protocol, such as for example and without wishing to be limited, modified XMPP protocol, which is modified by the system to support BitTorrent and RSS. Such an implementation increases the performance of the downloading, since each machine can download portions of the file list simultaneously from the consumer computer and from one or more of other machines into which this portion of the file list has already been loaded. In stage 7 each machine updates it's image (if needed) and runs the virtual machine. The machine preferably downloads the files in parallel from the consumers and/or from the other machines that are assigned for serving the current consumer. Updating the image is explained in greater details in FIGS. 6A-6D. In stage 8, each machine that is ready to run notifies its state to the consumer's computer. In stage 9, the consumer transfers one or more tasks with the data to the machine that is ready to run. The allocation of tasks to machines is preferably done by the server. Transfer is optionally done over XMPP protocol. The data optionally comprises data files, images and the like. Such files are being processed by the tasks that are running on this machine. In stage 10, the tasks are executing on the machine. While executing the consumer's computer preferably monitors the executing and optionally based on the SLA, (Service Level Agreement) is able to handle faults, by for example using checkpoint.

FIGS. 6A-6D are exemplary diagrams describing the generator process, which builds the delta directory tree on a machine. The delta directory tree is used for updating the image of the machine according to the requirements, which are specified in the file list. Delta directory tree defines to content of the current available images in the machine.

In order to avoid building the image from scratch every time a new consumer wishes to run its own tasks, the machine keeps the latest built images and the information regarding these images. The information is preferably kept in the delta directory tree. When a new request for an image arrives, the machine finds out the most suitable image and calculates the missing files (files that are required by the new image and do not exist in the chosen image). The machine downloads the missing files from the consumer or from one of the other machines that serve the current consumer and generates a new image. The previous image is preferably deleted. An exemplary scenario for building images and delta tree is when first consumer wishes to build an image that depends upon one version of glibc (GNU C library), second consumer wishes to build an image for running a program that depends upon the same version of glibc and MyQSL and third consumer wishes to build an image that includes few libraries or applications which use a different glibc version.

Referring now to the drawing; FIG. 6A describes a delta tree containing the root image and another node generated by the first request. The root image 611, according to this exemplary scenario contains files a, b and c which are described in root image file list 612. Preferably, the root image already exists when the machine is ready to serve the consumers. The machine also stores the file comprising the root image in order to enable the building of new images according to the future requirements. The root node 610 is preferably generated when the root image 611 is generated and preferably comprises the root image 611, root image file list 612 and pointers to root image files 613. When consumer A, according to the exemplary scenario, requests an image comprising files a and d as defined in the file list 622, the machine requests the files from the consumer and/or from the other machines that are allocated for this consumer. The machine builds the new image 624 and saves the new file d for future use. A new node delta A 620 is being added to the tree. The new node preferably comprises the delta file list 622, the new image 624 a list of pointers to files that build the image 623, for future use. At the end of the process delta tree 600 is comprised of root 610 and delta A node 620 and two images 611 and 624 are available for future use.

FIG. 6B illustrates an exemplary scenario in which a request from consumer B, according to the exemplary scenario is sent to the machine having the delta tree described in FIG. 6A. The request is described in delta B file list 732, which comprises the file e and a and a request for omitting files b and c from the image. Such a request for omitting files can be done, for example, when an application that has to run on the machine cannot run with another application that already exists in the image. The machine requests the file e from the consumer and/or from the other machines that are allocated for this consumer. The machine builds the new image 733 based on the root image 611, by removing files b and c and adding the file e. The machine preferably saves the new file e for future use. A new node delta B 730 is being added to the tree. The new node preferably comprises the delta file list 731, the new image 733 and a list of pointers to files that build the image, for future use 732. At the end of the process delta tree 700 is comprised of root 610, delta A node 620 and delta B node 730. It should be noted that three images are available by this machine at the end of the scenario.

FIG. 6C illustrates an exemplary scenario in which a request from consumer C, according to the exemplary scenario, is sent to the machine having the delta tree described in FIG. 6B. The request is described in delta C file list 821, which comprises the files c and f and a new version of file b (b′). The new version of b is preferably identified by the checksum of b′ which is different from the checksum of b. The machine chooses image 624 as the base image since it already contains file c. The machine requests the delta between b and b′ and also requests the file f from the consumer and/or from the other machines that are allocated for this consumer. The machine builds the new image 823 based on image 624 by adding the file f and by adding the necessary delta to construct b′. The machine preferably saves f and b′ for future use. Alternatively, the machine could request the signature from one of the nodes and could broadcast a request for the required file in that manner (for example, if file b is not in the root image).

A new node delta C 820 is being added to the tree. The new node preferably comprises the delta file list 821 the new image 823 and a list of pointers to files that build the image 822, for future use. The image 624 is preferably deleted. At the end of the process, delta tree 700 is comprised of root 610, delta A node 620, delta B node 730 and delta C node 820. It should be noted that three images 733, 823 and 611 are preferably available by this machine at the end of the scenario.

FIG. 6D illustrates an exemplary scenario in which a request from consumer D, according to the exemplary scenario, is sent to the machine having the delta tree described in FIG. 6C. The request is described in delta D file list 921, which comprises the files d, f and e. In this scenario the machine uses files from both images 733 and 823. The machine, in this case, does not need to request any file. The machine builds the new image 923 based on images 733 and 823 by combining all the files that are included in both images. A new node delta D 920 is being added to the tree. The new node 920 preferably comprises the delta file list 921, the new image 923 and a list of pointers to files that build the image 922, for future use. The images 823 and 733 are preferably deleted. At the end of the process delta tree 900 is comprised of root 610, delta A node 620 delta B node 730 delta C node 820 and delta D node 920. It should be noted that two images 611 and 923 are preferably available by this machine at the end of the scenario.

It should be noted that the user environment is transferred to the provider machine only when the job/task is transferred; as a result, the user environment is transferred after the new machine image has been created and is running.

While the invention has been described with respect to a limited number of embodiments, it will be appreciated that many variations, modifications and other applications of the invention may be made.

What is claimed is:

1. A system for generating cloud computing based on a plurality of providers for a plurality of consumers, the plurality of consumers providing a plurality of consumer requests for performing a plurality of tasks, comprising:
a. A server for allocating resources and for supporting the billing to the plurality of consumers;
b. A plurality of consumer computers for initiating said consumer requests and for transferring the required files for performing the consumer requests; and
c. A plurality of target machines for receiving said required files and for performing said tasks, wherein said plurality of target machines is owned by the plurality of providers.

2. The system of claim 1 wherein said server further validates the consumer requests.

3. The system of claim 1 wherein said consumer computers further monitor the execution of said tasks.

4. The system of claim 1 wherein said server and said consumer computer communicate via the Internet network.

5. The system of claim 1 wherein said server and said target machines communicate via the Internet network.

6. A method for generating cloud-computing based on a plurality of providers owning a plurality of target machines, comprising:
a. Issuing a request for resources required for executing tasks by a consumer computer;
b. Allocating one or more resources for the request by a server;
c. Updating the computer image of the plurality of target machines according to said request if necessary;
d. Transferring said one or more tasks to one or more target machines; and
e. Executing said one or more tasks on the one or more target machines.

7. The method of claim 6, wherein said request comprises at least a task list of one or more tasks, a file list of one or more files and hardware requirements executing said one or more tasks.

8. The method of claim 6, wherein said allocating said resources is done by matching target machines to the request.

9. The method of claim 8 wherein said matching is done by choosing machines complying with the hardware requirements and having a computer image which is similar or equal to the required image as determined according to said request.

9. The method of claim 6 wherein said updating the computer image of the target machine comprises downloading the image delta from at least one other target machine which is allocated for executing the request or from the consumer computer or a combination thereof.

10. The method of claim 6 further comprising transferring data to said target machines before executing said request.

11. The method of claim 6 further comprising monitoring said tasks during execution thereof.

12. A method for updating an image file on a machine connected to a plurality of other machines on a network, comprising:
a. Receiving a request comprising a file list for updating the image;
b. Choosing the most suitable image in the machine;
c. Retrieving the delta files from one or more of the other machines in the network; and
d. Building an updated image based on the most suitable image and the delta files.

13. The method of claim 12 wherein said machine has at least one root image prior to said updating.

14. The method of claim 12 wherein said most suitable image is the image having the maximal number of files that are requested for the updated image.

15. The method of claim 12 wherein said delta files comprise at least one file that is not included in said suitable image and that are required for building said updated image.

16. The method of claim 12 wherein said delta files comprise at least one file that is included in said suitable image having a different version then the version required for building said updated image.

17. The method of claim 12 further comprising deleting at least one file from said suitable image prior to said building of said updated image.

18. The method of claim 12 further comprising deleting said suitable image after building said updated image.

19. The method of claim 18 wherein, if said suitable image is the root image, said suitable image is not deleted after building said updated image.

20. The method of claim 12 further comprising storing the files that are used for said image building.

21. The method of claim 12, wherein the machine is a target machine for executing tasks, the method further comprising performing before updating the image file:
Issuing a request for performing one or more tasks by a consumer computer;
Allocating said target machine for the request by a server; and
The method further comprising performing after updating the image file:
Transferring said one or more tasks to said target machine; and
Performing said one or more tasks on said target machine;
Wherein said updating the image file is performed according to said request for performing one or more tasks.
